(19) United States
(12) Patent Application Publication
(10) Pub. No.: US 2026/0337090 A1
(43) Pub. Date: Oct. 29, 2026

(54) UV RADIATION ABSORBING GLASS COMPOSITIONS, ARTICLES, AND METHODS OF MAKING THE SAME

(71) Applicant: GÜROK HOLDING B.V., Amsterdam (NL)

(72) Inventors: Erhan KILINC, Sheffield (GB); Paul A. BINGHAM, Sheffield (GB)

(21) Appl. No.: 19/483,738

(22) PCT Filed: May 12, 2023
(86) PCT No.: PCT/IB2023/054949

§ 371 Date: Nov. 12, 2025

(51) Int. Cl. C03C 4/08; C03C 3/095

(52) U.S. Cl. CPC C03C 4/085; C03C 3/095

(57) ABSTRACT

Disclosed herein are glass compositions, articles made from the disclosed glass compositions, and methods of making the same. More specifically disclosed herein is a glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide, and wherein the glass is substantially free of erbium.

### TECHNICAL FIELD

The present invention generally relates to UV radiation adsorbing glass compositions, glass articles comprising the same, and methods of making the same.

### BACKGROUND

Humans learned how to manufacture glass articles more than 5,000 years ago. The modern utility of glass is very diverse and includes both commercial and consumer use. Glass is commonly used for commodity applications and technological applications related to the automotive industry, electronic industry, spectroscopy, and the like. Often glass articles are also exposed to various environments, and to ensure the article's durability in the long term, glass compositions need to be designed to withstand such environments. For example, glass articles such as container glasses, flat glasses for windows, automotive windshields, laser host materials, fibers, tubing, and the like, are employed in both commodity applications such as bottles, vases, art and craft glass objects, architectural windows, automotive windshields, and the like as well as technological applications such as glass tubing, glass fibers, laser host materials, and the like, often endure the environmental attack of moisture and can lose their initial properties as a result. In addition, glass containers are often used for keeping items that can be sensitive to UV radiation, and therefore it is important to form glass containers that could block the transmission of this radiation that could otherwise affect the quality or performance of the items placed in the containers.

There is a need to develop commercially viable low-UV ray transmitting glass compositions on the grounds of cost and workability of the glass melt. However, the addition of UV radiation absorbing oxides to soda-lime-silica glass imparts undesired colour tint. Thus, there is a need for fairly neutrally-coloured and high-visible light transmittive glass articles containing substantially lower amounts of chemical or physical decolorizers than are typically required for decolourization of low-UV ray transmitting container glasses. If desired, lightly tinted and high-visible light-transmissive glass articles can be produced.

These needs and other needs are at least partially satisfied by the present disclosure.

### SUMMARY

In various aspects, the present disclosure relates to a glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide, and wherein the glass is substantially free of erbium.

While yet in other aspects, when the glass is a soda-lime composition further comprising: from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; and from 0 to about 1 wt % of Li₂O. In still further aspects, the glass is a soda-lime-silica type composition.

In still further, the glass disclosed herein exhibits transmission of less than about 45% in a wavelength range from about 300 to about 380 nm. While in still further aspects, the glass exhibits transmission equal to or greater than about 80% in a wavelength range from greater than about 380 nm to about 780 nm. In still further aspects, the glass is substantially colorless.

Also disclosed herein is an article comprising any of the disclosed herein glasses. In still further aspects, the article can comprise foodware, tableware, hollowware, jars, optical fibers, hollow fibers, lab-usable containers, art and craft glass objects, or any combination thereof.

Also disclosed herein is an article comprising a glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide, and wherein the glass is substantially free of erbium.

Also disclosed herein are methods comprising: a) providing: from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; from 0 to about 1 wt % of Li₂O; from about 0.09 to about 1.00 wt % of cerium oxide; from about 0.01 to about 0.25 wt % of iron oxide; from about 0.01 to about 2.0 wt % of zinc oxide; and great than 0 wt % to less than about 0.08 wt % of titanium oxide; b) forming a homogeneous mixture; c) melting the mixture at a temperature from about 1,400 °C to about 1,500 °C for a first time to form a melted mixture, and d) forming any of the disclosed herein glasses, wherein the glass is substantially free of erbium.

In still further aspects, disclosed herein are methods of forming an article comprising any of the disclosed above glass compositions.

Additional aspects of the disclosure will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1 depicts the UV transmission as a function of cerium dioxide concentration in an exemplary glass according to one aspect.

FIG. 2 shows a* and b* values for various glass compositions according to one aspect.

FIG. 3 depicts the UV transmission as a function of various components present in an exemplary glass according to one aspect.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### DEFINITIONS

As used herein, the singular forms “a,” “an,” and “the” include plural referents unless the context clearly dictates otherwise. Thus, for example, reference to an “article” includes aspects having two or more such articles unless the context clearly indicates otherwise.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable combination.

As used herein, the terms “optional” or “optionally” mean that the subsequently described event or circumstance may or may not occur, and that the description includes instances where said event or circumstance occurs and instances where it does not.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as” and grammatical equivalences thereof, the phrase “and without limitation” is understood to follow unless explicitly stated otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts. It is understood that the term “glass composition,” as disclosed herein, refers to a glass that was melted to form a defined composition but before it was formed into a specific glass article. It is further understood that the glass composition as used herein is not the same as batch ingredients that were introduced into the mix before forming the glass. In some aspects, the batch ingredients used to form the composition can comprise elements that the glass composition is substantially free of.

A weight percent (wt. %) of a component, unless specifically stated to the contrary, is based on the total weight of the formulation or composition in which the component is included.

As used herein, the term “substantially” means that the subsequently described event or circumstance completely occurs or that the subsequently described event or circumstance generally, typically, or approximately occurs.

Still further, the term “substantially” can refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to indicate that the recited component is not intentionally batched and added to the composition but can be present as an impurity along with other components being added to the composition. In such aspects, the term “substantially free” is intended to refer to trace amounts that can be present in the batched components, for example, it can be present in an amount that is less than about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term “melting point” refers to a temperature at which the batch materials fully melt to obtain a homogeneous liquid. By glass industry convention, the melting point occurs at a liquid viscosity of around 10 Pa·s.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

The present invention may be understood more readily by reference to the following detailed description of various aspects of the invention and the examples included therein and to the Figures and their previous and following description.

### Compositions

In some aspects described herein is a glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide and wherein the glass is substantially free of erbium. It is understood that the cerium oxide can have any valency of cerium if it is applicable for the desired purpose. In some exemplary and non-limiting aspects, the cerium oxide is cerium dioxide (CeO₂). It is understood that the iron oxide can have any valency of iron if it is applicable for the desired purpose. In some exemplary and non-limiting aspects, the iron oxide is di-iron-trioxide (Fe₂O₃). It is further understood that in some other exemplary and non-limiting aspects, the iron oxide can also comprise iron oxide, or a mixture of di-iron-trioxide and iron oxide. Similarly, the titanium oxide can have any desired valency of titanium. In some exemplary and non-limiting aspects, the titanium oxide is titanium dioxide (TiO₂).

It is further understood that any of the disclosed herein oxides can have any desired valency for a non-oxygen element. For example, and without limitations the manganese oxide if present can include, for example, any of MnO, Mn₃O₄, Mn₂O₃, MnO₃, Mn₂O₇, or any combination thereof. In still further aspects, manganese oxide is MnO. Similarly, cobalt oxide can be present as CoO, Co₂O₃, Co₃O₄, or any combination thereof. In still further aspects, cobalt oxide is CoO.

In yet other aspects, the cerium oxide can be present from about 0.09 to about 1.00 wt %, including exemplary values of about 0.1 wt %, about 0.15 wt %, about 0.2 wt %, about 0.25 wt %, about 0.3 wt %, about 0.35 wt %, about 0.4 wt %, about 0.45 wt %, about 0.5 wt %, about 0.55 wt %, about 0.6 wt %, about 0.65 wt %, about 0.7 wt %, about 0.75 wt %, about 0.8 wt %, about 0.85 wt %, about 0.9 wt %, and about 0.95 wt %.

In still further aspects, the iron oxide is present from about 0.01 to less than 0.25 wt %, including exemplary values of about 0.02 wt %, about 0.025 wt %, about 0.03 wt %, about 0.035 wt %, about 0.04 wt %, about 0.045 wt %, about 0.05 wt %, about 0.055 wt %, about 0.06 wt %, about 0.065 wt %, about 0.07 wt %, about 0.075 wt %, about 0.08 wt %, about 0.085 wt %, about 0.09 wt %, about 0.095 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, and about 0.23 wt %.

In still further aspects, the zinc oxide is present from about 0.01 to about 2.0 wt %, including exemplary values of about 0.02 wt %, about 0.025 wt %, about 0.03 wt %, about 0.035 wt %, about 0.04 wt %, about 0.045 wt %, about 0.05 wt %, about 0.055 wt %, about 0.06 wt %, about 0.065 wt %, about 0.07 wt %, about 0.075 wt %, about 0.08 wt %, about 0.085 wt %, about 0.09 wt %, about 0.095 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.25 wt %, about 0.3 wt %, about 0.35 wt %, about 0.4 wt %, about 0.45 wt %, about 0.5 wt %, about 0.6 wt %, about 0.65 wt %, about 0.7 wt %, about 0.75 wt %, about 0.8 wt %, about 0.85 wt %, about 0.9 wt %, about 0.95 wt %, about 1.0 wt %, about 1.1 wt %, about 1.15 wt %, about 1.20 wt %, about 1.25 wt %, about 1.3 wt %, about 1.35 wt %, about 1.4 wt %, about 1.45 wt %, about 1.5 wt %, about 1.6 wt %, about 1.65 wt %, about 1.7 wt %, about 1.75 wt %, about 1.8 wt %, about 1.85 wt %, about 1.9 wt %, and about 1.95 wt %.

In still further aspects, the titanium oxide is present in an amount of greater than 0 wt % to about 0.1 wt % of titanium oxide, including exemplary values of about 0.00001 wt %, about 0.00005 wt %, about 0.0001 wt %, about 0.0002 wt %, about 0.0003 wt %, about 0.0004 wt %, about 0.0005 wt %, about 0.0006 wt %, about 0.0007 wt %, about 0.0008 wt %, about 0.0009 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, and about 0.09 wt %.

In certain aspects, in addition to cerium (present as cerium dioxide, for example), some other rare-earth elements can be present in the glass. In such aspects, the glass can comprise one or more additional rare-earth elements in addition to cerium (present as cerium dioxide, for example). It is understood that additional rare-earth elements include but are not limited to scandium, yttrium, lanthanum, praseodymium, neodymium, promethium, samarium, europium, gadolinium, terbium, dysprosium, holmium, thulium, ytterbium, and lutetium. In yet other aspects, none of these additional rare-earth elements are present. In still further aspects, the glass is substantially free of erbium.

In still further aspects, the glass is a soda-lime composition. In such aspects, the glass further comprises from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; from 0 to 0.5 wt % of SO₃; and from 0 to about 1 wt % of Li₂O.

In aspects where the glass is soda-lime composition, SiO₂ can be present from about 65 to about 75 wt %, including exemplary values of about 65.5 wt %, about 66 wt %, about 66.5 wt %, about 67 wt %, about 67.5 wt %, about 68 wt %, about 68.5 wt %, about 69 wt %, about 69.5 wt %, about 70 wt %, about 70.5 wt %, about 71 wt %, about 71.5 wt %, about 72 wt %, about 72.5 wt %, about 73 wt %, about 73.5 wt %, about 74 wt %, and about 74.5 wt %.

In aspects, where the glass is soda-lime composition, Na₂O can be present from about 8 to about 20 wt %, including exemplary values of about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, about 14.5 wt %, about 15 wt %, about 15.5 wt %, about 16 wt %, about 16.5 wt %, about 17 wt %, about 17.5 wt %, about 18 wt %, about 18.5 wt %, about 19 wt % and about 19.5 wt %.

In aspects, where the glass is soda-lime composition, CaO can be present from 0 to about 15 wt %, including exemplary values of about 0.01 wt %, about 0.05 wt %, about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 10.5 wt %, about 11 wt %, about 11.5 wt %, about 12 wt %, about 12.5 wt %, about 13 wt %, about 13.5 wt %, about 14 wt %, and about 14.5 wt %.

In aspects, where the glass is soda-lime composition, MgO can be present from 0 to about 10 wt %, including exemplary values of about 0.01 wt %, about 0.05 wt %, about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, and about 9.5 wt %.

In aspects, where the glass is soda-lime composition, Al₂O₃ can be present from 0 to about 5 wt %, including exemplary values of about 0.01 wt %, about 0.05 wt %, about 0.1 wt %, about 0.5 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, and about 4.9 wt %.

In aspects, where the glass is soda-lime composition, B₂O₃ can be present from 0 to about 3 wt %, including exemplary values of about 0.01 wt %, about 0.05 wt %, about 0.1 wt %, about 0.5 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, and about 2.9 wt %.

In aspects, where the glass is soda-lime composition, K₂O can be present from 0 to about 3 wt %, including exemplary values of about 0.01 wt %, about 0.05 wt %, about 0.1 wt %, about 0.5 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, and about 2.9 wt %.

In aspects, where the glass is soda-lime composition, Li₂O can be present from 0 to about 3 wt %, including exemplary values of about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, and about 0.9 wt %.

Also disclosed herein are the aspects where any of the disclosed above glasses can further comprise from about 0 to about 0.5 wt % of SO₃, including exemplary values of about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.15 wt %, about 0.2 wt %, about 0.25 wt %, about 0.3 wt %, about 0.35 wt %, about 0.4 wt %, and about 0.45 wt %

Also disclosed herein are the aspects where any of the disclosed above glasses can further comprise from 0 to about 0.02 wt % of Co oxide, including exemplary values of about 0.00001 wt %, about 0.00005 wt %, about 0.0001 wt %, about 0.0005 wt %, about 0.001 wt %, about 0.005 wt %, about 0.006 wt %, about 0.007 wt %, about 0.008 wt %, about 0.009 wt %, about 0.01 wt %, about 0.011 wt %, about 0.012 wt %, about 0.013 wt %, about 0.014 wt %, about 0.015 wt %, about 0.016 wt %, about 0.017 wt %, about 0.018 wt %, and about 0.019 wt %.

Also disclosed herein are the aspects where any of the disclosed above glasses can further comprise from 0 to about 0.02 wt % of selenium, including exemplary values of about 0.00001 wt %, about 0.00005 wt %, about 0.0001 wt %, about 0.0005 wt %, about 0.001 wt %, about 0.005 wt %, about 0.006 wt %, about 0.007 wt %, about 0.008 wt %, about 0.009 wt %, about 0.01 wt %, about 0.011 wt %, about 0.012 wt %, about 0.013 wt %, about 0.014 wt %, about 0.015 wt %, about 0.016 wt %, about 0.017 wt %, about 0.018 wt %, and about 0.019 wt %.

Also disclosed herein are the aspects where any of the disclosed above glasses can further comprise from about 0.01 to about 1 wt % of manganese oxide, including exemplary values of about 0.02 wt %, about 0.025 wt %, about 0.03 wt %, about 0.035 wt %, about 0.04 wt %, about 0.045 wt %, about 0.05 wt %, about 0.055 wt %, about 0.06 wt %, about 0.065 wt %, about 0.07 wt %, about 0.075 wt %, about 0.08 wt %, about 0.085 wt %, about 0.09 wt %, about 0.095 wt %, about 0.1 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.25 wt %, about 0.3 wt %, about 0.35 wt %, about 0.4 wt %, about 0.45 wt %, about 0.5 wt %, about 0.6 wt %, about 0.65 wt %, about 0.7 wt %, about 0.75 wt %, about 0.8 wt %, about 0.85 wt %, about 0.9 wt %, about 0.95 wt %, about 1.0 wt %, about 1.1 wt %, about 1.15 wt %, about 1.20 wt %, about 1.25 wt %, about 1.3 wt %, about 1.35 wt %, about 1.4 wt %, about 1.45 wt %, about 1.5 wt %, about 1.6 wt %, about 1.65 wt %, about 1.7 wt %, about 1.75 wt %, about 1.8 wt %, about 1.85 wt %, about 1.9 wt %, and about 1.95 wt %.

In still further aspects, the glasses disclosed herein can further comprise an amount of CuO, Cu₂O, NiO, Cr₂O₃, Sb₂O₃, P₂O₅, As₂O₃, or a combination thereof. In such aspects, these compounds can be present independently of each other in an amount greater than 0 but less than about 5 wt %, less than about 4 wt %, less than about 3 wt %, less than about 2 wt %, less than about 1 wt %, less than about 0.5 wt %, or less than about 0.1 wt %. In yet still further aspects, these compounds can be present independently of each other in an amount from greater than 0 to less than about 5 wt %, including exemplary values of about 0.00001 wt %, about 0.00005 wt %, about 0.0001 wt %, about 0.0005 wt %, about 0.001 wt %, about 0.005 wt %, about 0.01 wt %, about 0.05 wt %, about 0.1 wt %, about 0.5 wt %, about 1 wt %, about 1.5 wt %, about 2 wt %, about 2.5 wt %, about 3 wt %, about 3.5 wt %, about 4 wt %, and about 4.5 wt %. It is further understood that these compounds can be present as impurities or can be deliberately added to the glass composition if desired in any of the mentioned above amounts.

In yet still further aspects, the glass exhibits transmission of less than about 45%, less than about 40%, less than about 30%, less than about 25%, less than about 20%, less than about 15%, less than about 10%, less than about 5%, or less than about 1% in a wavelength range from about 300 to about 380 nm, including exemplary wavelengths of about 300 nm, about 310 nm, about 320 nm, about 330 nm, about 340 nm, about 350 nm, about 360 nm, about 370 nm, and about 380 nm. It is understood that these wavelengths are only exemplary, and all wavelengths present in the range of 300-380 nm are included.

In still further aspects, the glass disclosed herein exhibits transmission equal to or greater than about 80%, equal to or greater than about 85%, or equal to or greater than about 90%, in a wavelength range from greater than 380 nm to about 780 nm, including the exemplary wavelength of about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, and about 780 nm. It is understood that these wavelengths are only exemplary, and all wavelengths present in the range greater than 380 to 780 nm are included. In still further aspects, the glass disclosed herein exhibits transmission about 80% to about 93%, including exemplary values of about 81%, about 82%, about 83%, about 84%, about 85%, about 86%, about 87%, about 88%, about 89%, about 90%, about 91%, and about 92%, in a wavelength range from greater than 380 nm to about 780 nm, including the exemplary wavelength of about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, and about 780 nm.

In still further aspects, the glass is substantially colorless. In yet other aspects, the glass is colorless. In still further aspects, the glass can have a shade of color depending on the desired application. For example, and without limitations, the shade can be blue-green tint.

In still further aspects, it is understood that the glass disclosed herein can be defined by at least one of L, a*, and/or b* values, where L defines the lightness of the glass, a* defines red/green value, and b* defines blue/yellow value.

In such aspects, the glass disclosed herein can exhibit a* from about −3 to about +3, including exemplary values of about −2.9, about −2.8, about −2.7, about −2.6, about −2.5, about −2.4, about −2.3, about −2.2, about −2.1, about −2.0, about −1.9, about −1.8, about −1.7, about −1.6, about −1.5, about −1.4, about −1.3, about −1.2, about −1.1, about −1.0, about −0.9, about −0.8, about −0.7, about −0.6, about −0.5, about −0.4, about −0.3, about −0.2, about −0.1, −0.0, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, and about 2.9.

In further aspects, the glass disclosed herein can exhibit b* from 0 to about +3, including exemplary values of about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, and about 2.9.

In still further aspects, the glass disclosed herein can be defined by a redox value. It is understood that in this disclosure, this redox value is defined by the weight % of ferrous iron to the total iron concentration. In such aspects, the glass disclosed herein can exhibit a redox value from 0% to about 50%, including exemplary values of about 1%, about 5%, about 10%, about 15%, about 20%, about 25%, about 30%, about 35%, about 40%, about 45%, and about 49%.

### Articles

Also disclosed herein are articles comprising any of the disclosed above compositions. For example and without limitations, disclosed herein is an article comprising a glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide, and wherein the glass is substantially free of erbium.

As discussed in detail above, it is understood that the cerium oxide can have any valency of cerium if it is applicable for the desired purpose. In some exemplary and non-limiting aspects, the cerium oxide is cerium dioxide (CeO₂). It is understood that the iron oxide can have any valency of iron if it is applicable for the desired purpose. In some exemplary and non-limiting aspects, the iron oxide is di-iron-trioxide (Fe₂O₃). It is further understood that in some other exemplary and non-limiting aspects, the iron oxide can also comprise iron oxide, or a mixture of di-iron-trioxide and iron oxide. Similarly, the titanium oxide can have any desired valency of titanium. In some exemplary and non-limiting aspects, the titanium oxide is titanium dioxide (TiO₂).

It is further understood that any of the disclosed herein oxides can have any desired valency for a non-oxygen element. For example, and without limitations the manganese oxide if present can include, for example, any of MnO, Mn₃O₄, Mn₂O₃, MnO₃, Mn₂O₇, or any combination thereof. In still further aspects, manganese oxide is MnO. Similarly, cobalt oxide can be present as CoO, Co₂O₃, Co₃O₄, or any combination thereof. In still further aspects, cobalt oxide is CoO.

It is understood that any of the components present in the glass can have any of the disclosed above values.

In still further aspects, any of the disclosed above additional elements can be present in any of the disclosed above amounts in the glass compositions used to form the disclosed herein articles.

In yet still, further aspects, the articles disclosed herein can have a light transmission of less than about 45%, less than about 40%, less than about 30%, less than about 25%, less than about 20%, less than about 15%, less than about 10%, less than about 5%, or less than about 1% in a wavelength range from about 300 to about 380 nm, including exemplary wavelengths of about 300 nm, about 310 nm, about 320 nm, about 330 nm, about 340 nm, about 350 nm, about 360 nm, about 370 nm, and about 370 nm. It is understood that these wavelengths are only exemplary, and all wavelengths present in the range of about 300-380 nm are included.

In still further aspects, the articles disclosed herein exhibit transmission equal to or greater than about 80%, equal to or greater than about 85%, or equal to or greater than about 90%, in a wavelength range from greater than 380 nm to about 780 nm, including the exemplary wavelength of about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, and about 780 nm. It is understood that these wavelengths are only exemplary, and all wavelengths present in the range greater than 380 to 780 nm are included. In still further aspects, the glass disclosed herein exhibits transmission about 80% to about 93%, including exemplary values of about 81%, about 82%, about 83%, about 84%, about 85%, about 86%, about 87%, about 88%, about 89%, about 90%, about 91%, and about 92%, in a wavelength range from greater than 380 nm to about 780 nm, including the exemplary wavelength of about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, and about 780 nm. It is understood that these wavelengths are only exemplary, and all wavelengths present in the range greater than 380 to 780 nm are included.

In still further aspects, the article made from the disclosed glass is substantially colorless. In yet other aspects, the article made from the disclosed glass is colorless. In still further aspects, the made from the disclosed glass can have a shade of color depending on the desired application. In certain aspects, the article can have a blue-green tint. Without wishing to be bound by any theory, it is assumed that such shade can be due to the presence of cerium, iron, chromium, cobalt, and/or copper oxides in the glass composition.

In such aspects, the article made from the disclosed glass can exhibit a* from about −3 to about +3, including exemplary values of about −2.9, about −2.8, about −2.7, about −2.6, about −2.5, about −2.4, about −2.3, about −2.2, about −2.1, about −2.0, about −1.9, about −1.8, about −1.7, about −1.6, about −1.5, about −1.4, about −1.3, about −1.2, about −1.1, about −1.0, about −0.9, about −0.8, about −0.7, about −0.6, about −0.5, about −0.4, about −0.3, about −0.2, about −0.1, −0.0, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, and about 2.9.

In further aspects, the article made from the disclosed glass can exhibit b* from 0 to about +3, including exemplary values of about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, and about 2.9.

In further aspects, the article made from any of disclosed herein glasses can exhibit a redox value from 0% to about 50%, including exemplary values of about 1%, about 5%, about 10%, about 15%, about 20%, about 25%, about 30%, about 35%, about 40%, about 45%, and about 49%.

In still further aspects, the articles can comprise any known in the art articles that require the disclosed herein mechanical, chemical, and optical properties. Yet in other aspects, the articles disclosed herein can comprise a hollowware, tableware, container, plate, sheet (including sheets prepared via the float process), cookware, or any combination thereof. In still further aspects, the articles can comprise foodware, tableware, cookware, flat glass, windows, windshields, hollowware, jars, art and craft glass objects, lab-usable containers, or any combination thereof.

Various shaping methods can be used to make the desired articles or to provide a desired shape to the glass. For example, shaping methods, such as casting, molding, pressing, rolling, floating, and the like can be utilized. In yet further aspects, the articles disclosed herein can be formed by a float/flat glass press process, a press-and-blow process, a blow-and-blow process, or any combination thereof. Yet in still further aspects, the methods can also comprise glassblowing, hot casting, flameworking,

In yet still further aspects, the articles can comprise foodware, tableware, cookware, hollowware, jars, optical fibers, hollow fibers, lab-usable containers, art and craft glass objects, or any combination thereof. In such aspects, the glass article can be formed by pressed and/or blown or blow-and-blow process.

In still further aspects, the glass article can comprise flat glass, windows, windshields, solar cell parts, art and craft glass objects, laser host materials, or any combination thereof. In such aspects, the glass article can be formed by a flat/float process.

In still further aspects, the articles disclosed herein can have any known in the art shape or configuration.

### Methods

Also disclosed herein are methods of making the disclosed compositions and the disclosed articles. In certain aspects, disclosed herein are methods comprising: a) providing: from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; from 0 to about 1 wt % of Li₂O; from about 0.09 to about 1.00 wt % of cerium oxide; from about 0.01 to about 0.25 wt % of iron oxide; from about 0.01 to about 2.0 wt % of zinc oxide; and great than 0 wt % to less than about 0.08 wt % of titanium oxide; b) forming a homogeneous mixture; c) melting the mixture at a temperature from about 1,400 °C to about 1,500 °C for a first time to form a melted mixture, and d) forming any of the disclosed herein glasses, wherein the glass is substantially free of erbium.

Again, as discussed in detail above, it is understood that the cerium oxide can have any valency of cerium if it is applicable for the desired purpose. In some exemplary and non-limiting aspects, the cerium oxide is cerium dioxide (CeO₂). It is understood that the iron oxide can have any valency of iron if it is applicable for the desired purpose. In some exemplary and non-limiting aspects, the iron oxide is di-iron-trioxide (Fe₂O₃). It is further understood that in some other exemplary and non-limiting aspects, the iron oxide can also comprise iron oxide, or a mixture of di-iron-trioxide and iron oxide. Similarly, the titanium oxide can have any desired valency of titanium. In some exemplary and non-limiting aspects, the titanium oxide is titanium dioxide (TiO₂).

It is further understood that any of the disclosed herein oxides can have any desired valency for a non-oxygen element. For example, and without limitations the manganese oxide if present can include, for example, any of MnO, Mn₃O₄, Mn₂O₃, MnO₃, Mn₂O₇, or any combination thereof. In still further aspects, manganese oxide is MnO. Similarly, cobalt oxide can be present as CoO, Co₂O₃, Co₃O₄, or any combination thereof. In still further aspects, cobalt oxide is CoO.

It is further understood that the provided compounds can be provided in any amounts described above.

In still further aspects, the temperature can be from about 1,400 °C to about 1,500 °C, including exemplar values of about 1,410 °C, about 1,420 °C, about 1,430 °C, about 1,440 °C, about 1,450 °C, about 1,460 °C, about 1,470 °C, about 1,480 °C, and about 1,490 °C.

In still further aspects, the forming of the glass comprises cooling the melted mixture to room temperature. It is understood that the cooling can be done at any desirable rate.

In still further aspects, the melted mixture is annealed prior to the cooling at a temperature of about 520 to about 590 °C, including exemplary values of about 525 °C, about 530 °C, about 535 °C, about 540 °C, about 545 °C, about 550 °C, about 555 °C, about 560 °C, about 565 °C, about 570 °C, about 575 °C, about 580 °C, and about 585 °C.

In still further aspects, the method further comprises forming an article comprising any of the disclosed herein glasses. In such aspects, the article can be any of the articles disclosed herein.

In still further aspects, the methods disclosed herein comprise a step of forming a glass article. Any known in the art methods of forming or shaping an article can be utilized. For example, and without limitation, the methods of forming a glass article disclosed herein can comprise down drawing (by either a slot draw or fusion draw process), fiber-drawing, float processing, or thin rolling of the glass. In yet other aspects, the methods can comprise shaping the glass to any desired shape. Various shaping methods can also be used, such as casting, molding, pressing, rolling, drawing, floating, and the like. In yet further aspects, the articles disclosed herein can be formed by a float/flat glass press process, a press-and-blow process, a blow-and-blow process, or any combination thereof. Yet in still further aspects, the methods can also comprise glassblowing, hot casting, flame working. It is further understood that other low temperature glass-making methods can also be utilized. For example, and without limitations, glass wheel forming methods are also contemplated.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for.

### Example 1

UV radiation absorbing highly transparent and colorless or neutral color soda-lime-silica glass compositions are developed. In non-limiting examples shown herein, glass can contain cerium and iron oxides as UV-absorbing agents. It was unexpectedly found that iron (II) oxide can reduce transmission of UV radiation in soda-lime-silica glass, and cerium dioxide can improve visible light transmittance of iron-containing UV absorbing glass.

Without wishing to be bound by any theory, it was hypothesized that a mixture of iron (II), iron (III), cerium (III) and cerium (IV) oxides can produce synergistic UV absorbing effects and favorable visible light transmittance. Previously it was demonstrated that the addition of UV absorbing oxides can impart undesirable color tints to the glass body, and therefore decolorization of such glasses may require high levels of physical and chemical decolourisers and which may subsequently reduce visible light transmittance and clarity of glass products. The inventors have unexpectedly discovered that the addition of zinc oxide can neutralize yellowish and greenish tints caused by cerium and iron oxides by shifting chromatic values of a* and b* to more neutral values, and therefore can bleach visible color in UV radiation absorbing glass. It was found that even small amounts of physical or chemical decolorizers added to the glass can allow for obtaining more neutral-colored and highly transparent UV-absorbing glass compositions.

The glasses disclosed in this example are modified soda-lime-silica glass compositions, which can be used in the production of tableware and container glass. Glass compositions for producing low ultraviolet radiation (UV) transmitting articles may exhibit a neutral color or if desired, lightly tinted and high visible light transmission glasses.

Traditional flint (colorless) container glass transmits a significant portion of UV radiation; therefore, foodstuffs contained in flint container glasses are directly exposed to the harmful effects of UV radiation. Ultraviolet radiation degrades vitamins, proteins and lipids in foods, and the generated photo-degradation products can lead to discoloration, undesired odor, as well as loss of aroma, taste and essential nutrients in foodstuffs. Therefore green and amber glass containers are preferred to reduce or completely prevent the UV radiation-induced degradation of foodstuffs; however, colored glass containers mask the content of the containers, and therefore they may not be desirable for users. Furthermore, it is known that melting, refining and conditioning of such colored glass melts tend to be more difficult than working with flint glass melts. It is, therefore, soda-lime-silicate glass compositions that absorb significant portions of ultraviolet radiation that have been disclosed in this invention.

This non-limiting example presents a fairly neutral or tinted glass; for a thickness (l) of ~5.2 mm, having a visible light transmission (i.e., Tᵥ≥80) between (and including) 380 and 780 nm and a low transmission of UV radiation (i.e., Tᵤᵥ<45) between 300 and 380 nm (and including). Based on spectral calculations, iron redox of example glasses (weight %. ferrous iron/total iron) concentration is less than 50% for cerium, iron and zinc oxide-containing glasses. Glasses in this disclosure include cerium dioxide, di-iron trioxide, zinc oxide and preferably cobalt oxide and selenium. Cerium oxide can be in a range of 0.09-1.00 wt. % (more preferably less than 1.0 wt %, and most preferably less than 0.5 wt. %), di-iron trioxide a range of from 0.01-0.25 wt. % and more preferably a range of 0.125 and 0.25 wt. %, here total iron oxide is expressed as the sum of ferric and ferrous in a glass matrix. Cobalt oxide and selenium can be used to decolorize or compensate for the yellowish tint of the glass, and the amount of cobalt oxide and selenium can range from 0 to 0.02% each, depending on the iron redox as well as the amount of optical absorbents (particularly cerium dioxide and di-iron trioxide) present in the glass. Table 1 shows a summary of an exemplary glass composition used in the current disclosure.

It was unexpectedly found that cerium dioxide coupled with di-iron trioxide can provide more cost-efficient UV absorbance in certain aspects of this disclosure. Cerium and iron oxides as UV absorbents also impart yellow coloration in the glass, and the yellow color can be decolorized more effectively than the green coloration in the glass. Further to this, the addition of zinc oxide bleaches the yellow coloration caused by the addition of cerium and iron (III) oxides substantially and shifts chromatic values of b* to more neutral values (a positive and negative sign of b* represent a yellow and blue component of the color, respectively); and more interestingly and unexpectedly zinc oxide removes the greenish tint caused by a combination of iron (II) and iron (III) oxides or impurities such as chromium oxide, and moves chromatic values of a* to more neutral values using the L*-a*-b* color coordinate system.

TABLE 1
Glass composition

| | |
|---|---|
| Cerium dioxide (total cerium) | 0.09-1.00% |
| Di-iron trioxide (total iron) | 0.01-0.25% |
| Zinc oxide (total zinc) | 0.01-2.00% |
| Cobalt oxide | 0.00-0.02% |
| Selenium | 0.00-0.02% |

The definition of soda-lime-silica glass here is in its widest sense, and it relates to any glass compositions which can comprise the following oxides—but not limited to them—within their specified compositional range (concentrations are defined by weight percentage, Table 2):

TABLE 2
Example Soda-Lime-Silica Glass composition

| | |
|---|---|
| SiO₂ | 65-75% |
| Na₂O | 8-20% |
| CaO | 0-15% |
| MgO | 0-10% |
| Al₂O₃ | 0-5% |
| B₂O₃ | 0-3% |
| K₂O | 0-3% |
| Li₂O | 0-1% |
| SO₃ | 0.0-0.50% |

In this example, silicate glass contains SiO₂, which is the main network former in glass, and therefore total SiO₂ content should be in a range of 65-75 wt. %. Otherwise, silica contents lower than the proposed range can deteriorate the chemical durability and crystallization properties of glass, and SiO₂ contents higher than the specified range can deteriorate the melting, refining and crystallization properties of the glass melt. It should be noted that crystallization properties in this patent refer to mainly liquidus temperature and the rate of crystal growth, and the extent of variation of these crystallization properties can also be linked to the crystal phase field of glass.

Na₂O is the main network modifier or fluxing agent in the glass, and it should be in a range of 8-20 wt %, and the concentrations of Na₂O lower than the proposed range can deteriorate the meltability and crystallization properties of glass melt. Na₂O concentrations higher than the given range impair chemical durability, thermal shock resistance and forming properties of glass melt.

K₂O can also be added to glass as a network modifier or fluxing agent. Addition of K₂O is not essential, but the coexistence of K₂O with Na₂O can improve the mechanical properties and chemical durability of the glass due to the mixed-alkali effect. However, the amounts of K₂O should be restricted to up to and including 3 wt % as it is an expensive fluxing agent, and its excessive incorporation in the glass matrix can reduce the hydrolytic resistance of the final glass product.

Li₂O can also be added to glass as a network modifier or fluxing agent. Addition of Li₂O is not essential, but the addition of small amounts of Li₂O can reduce the melting and refining temperature/time of the glass melt. However, Li₂O is a very expensive component, and excessive additions may deteriorate the crystallization properties of glass melts. Therefore Li₂O can be in a range of 0-1.0 wt % in the glass.

B₂O₃ can also be added to glass as a network former or fluxing agent. Addition of B₂O₃ is not essential, but the addition of B₂O₃ can significantly improve the meltability of soda-lime-silica glass; however, B₂O₃ is a relatively expensive component, and excessive additions may increase Na₂O volatilization from glass melts; therefore B₂O₃ can range from 0 to 3.0 wt. % in the glass.

Al₂O₃ can be added as a network former in glass to improve particularly crystallization properties of melts and mechanical properties of the final glass. The presence of Al₂O₃ is desired but not essential; however, excessive additions of Al₂O₃ can deteriorate melting, refining, crystallization and forming properties of glass melt. Therefore the range of Al₂O₃ can be in the range of 0.0-5.0 wt % in the final glass.

CaO behaves as a network modifier in glass networks and can be used as a high temperature melting flux. The presence of CaO significantly improves the chemical resistance and mechanical properties (Elastic moduli and Vicker's hardness) of sodium-silicate glasses, and CaO should be present in glass not greater than 15 wt % as it may significantly increase liquidus temperature and the rate of crystallization of soda-lime-silicate glass melts. Therefore CaO can be in a range of 0-15 wt. % in the glass.

MgO can be used in combination with CaO in soda-lime-silica glasses; partial replacement of CaO by MgO can lower density and reduce liquidus temperature of glass melts significantly and hence increases the temperature difference between gob forming and liquidus temperatures. The literature also reports that MgO reduces the rate of crystal growth in melts in near- or sub-liquidus temperature regions. MgO preferably can be present in glasses in a range of 0-10 wt. %; however, the more preferred level of MgO in the glass can be in a range of 0-7.0 wt % as excessive use of MgO, particularly above 7 wt % can deteriorate crystallization properties and can also increase melting temperature of glass melts.

SO₃ facilitates fining of soda-lime-silica melts, and therefore it can be incorporated in glasses through the addition of sodium or barium sulfate, gypsum or other forms of SO₃-bearing minerals or compounds to glass batches. Glass compositions that fall within the defined compositional range can be melted under oxidizing or reducing conditions in order to control fining of glass melts and to obtain desired final color specifications. It is not limited to, but preferably dissolved sulfur in the form of SO₃ can be in a range of 0-0.5 wt. % in soda-lime-silica glass, depending on the desired processing parameters.

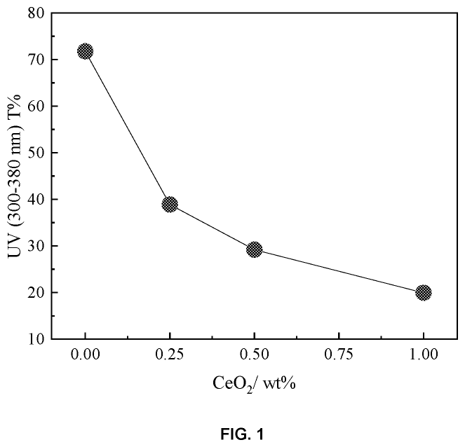

Cerium oxide can be found in Ce³⁺ and Ce⁴⁺ states in soda-lime-silica melts, and the addition of cerium dioxide significantly reduces the transmission of UV radiation in certain embodiments of the invention. However, this effect does not vary linearly with the concentration of cerium oxide (see FIG. 1), and levels of 0.5 wt. % or can be in the range of 0.25 and 0.5 wt. % would be the optimum concentrations for cerium oxide to be used. Chromatic value of b* significantly shifts to more positive values due to the presence of cations of Fe³⁺ and Ce⁴⁺ in example glasses.

A mixture of ferrous and ferric oxides can exist in soda-lime-silica glasses as an impurity, or iron oxide can be incorporated deliberately into float/flat glass for controlling solar control properties. Iron redox can be adjusted by changing the batch redox number and furnace atmosphere. Ferric and ferrous oxides impart green-bluish and yellowish tints, respectively, in the soda-lime-silica glass. Ferric and ferrous oxides absorb the ultraviolet and infrared portions of the light spectrum, respectively.

Silica sand can contain titanium dioxide as an impurity and therefore trace amounts of titanium dioxide (for example, less than 0.1 wt. %) can be present in the soda-lime-silica glass. Titanium dioxide can exist in various coordination states in soda-lime-silica glass, depending on the melting conditions (redox), glass composition and interaction with other types of cations. For instance, Ti⁴⁺ and Ti³⁺ impart yellow and brownish/purplish tints in soda-lime-silica glass, respectively. Titanium dioxide can be added to glass to improve the absorption of UV radiation when further additions of cerium dioxide do not effectively reduce UV ray transmission.

Cobalt oxide and selenium can be added in order to decolorize unwanted tints in glass bodies, and cobalt oxide can be used to compensate for the yellowish tint caused by the addition of UV absorbents of iron (III) and cerium oxides. However, excessive use of cobalt oxide can reduce visible light transmittance of UV-absorbing glasses. Selenium can also be incorporated in the UV-absorbing glass matrix; however, selenium is very volatile and therefore achieving stable decolorization is difficult, and the addition of excessive selenium can also reduce visible light transmittance and brilliance of UV-absorbing glass. On the other hand, zinc oxide behaves similarly to cobalt oxide and selenium and shifts a* and b* values to more neutral parts of the L*-a*-b* diagram, and successfully removing undesired greenish and yellowish tint without compromising the visible light transmittance and brilliance of UV absorbing glass. On the grounds of cost, preferably, zinc oxide can be used in combination with relatively low levels of cobalt oxide and selenium to fully decolorize the UV-absorbing glass.

It should be noted that soda-lime-silica glass can contain any other oxides in the form of impurities including, but not limited to, NiO, Cr₂O₃, Sb₂O₃, P₂O₅, As₂O₃, Er₂O₃ or MnO₂.

The oxides herein disclosed can be incorporated into the glass structure by any conventional method. For instance, the disclosed UV absorbents and/or decolorization agents can be incorporated into the glass by mixing with other raw materials and can be fed into a glass melting tank. Furthermore, UV absorbents and/or decolorization agents can also be fed to a preferred forehearth in the form of low melting glass, frit or agglomerates to achieve the desired glass composition, which can provide flexibility over coloring and adjusting the production capacity of the UV absorbing glass products.

### Example 2

Raw materials are batched to obtain the benchmark and example glasses, whose chemical compositions are tabulated in Table 3-7. Glass batch is melted in a Pt crucible in an air medium for around 12 hours at temperatures in a range of 1425-1450 °C considering modeled melting temperature; afterward the glass melt is poured and fritted and re-melted for another 12 hours in air medium for compositional homogenization. In total, 24 hours of melting in ambient air are deemed to be sufficient for the redox equilibrium of optical absorbents in glass melts to be reached. The glass melt is then cast onto a stainless steel mold and annealed at its expected annealing temperature for one hour, and then cooled to room temperature. A small fraction of total Na₂O in the glass is provided from sodium sulfate, added to improve the refining of the glass.

Cast glass bars were cut and polished to form specimens of ~5.2 mm thickness. A Shimadzu 3600—UV-Vis-nIR spectrophotometer was used to measure the UV-Vis-nIR spectra of the produced glass samples in the range 190-2500 nm. T_{UV} denotes the calculated total transmission of ultraviolet radiation in a range of 300-380 nm, and T_{UV} values were calculated according to the procedure given in the ISO BS 9050 standard, and similarly, the overall light transmission (T_{V}) in a range of 380 and 780 nm was calculated according to the methodology given in ISO BS 9050. The colorimetric CIE values of L*, a* and b* were calculated using the D65 illuminant and 10° observer considering the CIE 1931 standards. Spectral iron redox was calculated using the correlation of Ceglia et al. (2015) for soda-lime-silica glass, as follows:

$${C}_{F {e}^{+ 2}} = ( \frac{{A}_{1100} + 0.01}{1.23} ) \qquad ( 1 )$$

wherein C_{Fe}_{²⁺} is the concentration of iron (II) ions in % wt. in glass, and A₁₁₀₀ is the normalized absorption of example glasses to a thickness of 1 mm.

### Example 3

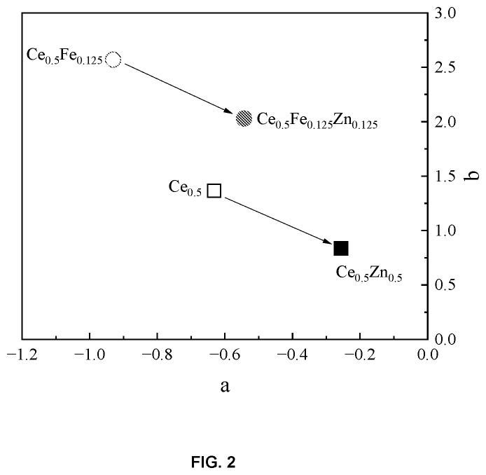

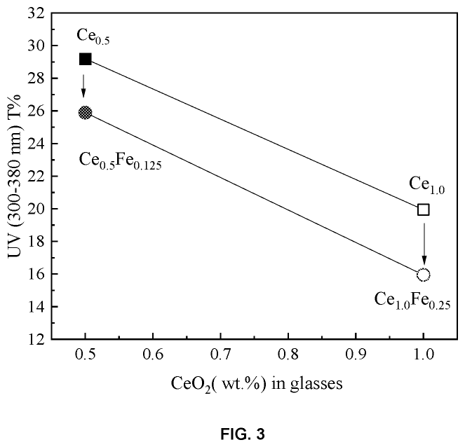

The composition of Ex. 1, which is given in Table 3, represents the benchmark glass composition, and Ex. 2 is obtained by a single addition of 0.25 wt. % di-iron trioxide to Ex. 1 (base glass). This addition was found to reduce the ultraviolet transmission of the Benchmark glass as shown in Ex. 2 with iron redox (FeO/ΣFeO+Fe₂O₃) of 91.42%, and this surprisingly demonstrates that Fe²⁺ ions also significantly absorb UV radiation in soda-lime-silica glasses. Without wishing to be bound by any theory, it was suggested that some fraction of the total iron oxide should be found in the divalent state in UV radiation-absorbing glass matrices, and therefore redox values can be in a range of 10-50% might be preferred as ideal iron redox values for UV absorbing glasses. Similarly, an unexpected reduction in UV radiation transmission can be observed for 0.25 wt. % cerium oxide-containing glasses in Ex. 3. It was found, however, further additions of CeO₂ in Ex. 4 and 5 do not reduce UV transmission as is expected when considering the individual effect of cerium dioxide in Ex. 3 (See FIG. 1). Furthermore, the addition of di-iron trioxide to cerium oxide containing glasses, as shown by Ex. 6 and 7, can further reduce the transmission of ultraviolet radiation to nearly equivalent to that of excess cerium dioxide levels above 0.25 wt. % (See FIG. 3), and the iron redox of Ex. 7 decreases to the value of 31.5% with the addition of 1 wt. % cerium dioxide. Incorporation of di-iron trioxide slightly reduces visible light transmittance, as is observed in Ex. 2, whereas Ex. 6 and 7 demonstrate that incorporation of cerium dioxide can remarkably improve visible light transmittance of iron-containing glasses. Addition of 0.125 wt. % zinc oxide to the glass in Ex. 6 moves chromatic values of a* and b* to more neutral values, and the value of a* shifts from −0.93 to −0.54 and the value of b* moves from 2.57 to 2.03 in Ex. 8. Moreover, the addition of 0.5 wt. % zinc oxide to the glass in Ex. 4 moves the value of a* from −0.63 to −0.26 and the value of b* from 1.37 to 0.84 in Ex. 9 (See FIG. 2).

TABLE 3
Benchmark Glass composition

| Oxide | Wt % |
|---|---|
| SiO₂ | 70.750 |
| Na₂O | 13.700 |
| CaO | 8.830 |
| MgO | 3.930 |
| Al₂O₃ | 1.620 |
| K₂O | 0.110 |
| SO₃ | 0.200 |
| TiO₂ | 0.063 |
| Fe₂O₃ | 0.047 |
| B₂O₃ | 0.750 |
| Total | 100.00 |

TABLE 4

| Oxides | Ex. 1 Base Glass wt % | Ex. 2 Fe_{0.297} wt % |
|---|---|---|
| TiO₂ | 0.063 | 0.063 |
| ZnO | 0 | 0 |
| Fe₂O₃ | 0.047 | 0.297 |
| CeO₂ | 0 | 0 |

Properties

| | | |
|---|---|---|
| T_{UV} % | 71.75 | 39.16 |
| T_{V} % | 90.730 | 86.291 |
| L* | 96.29 | 94.42 |
| a* | −0.65 | −3.033 |
| b* | 0.44 | 1.6966 |
| / | 5.23 | 5.25 |
| FeO % (Spectral) | 37.99 | 91.42 |

TABLE 5

| | Ex. 3 | Ex. 4 | Ex. 5 |
|---|---|---|---|
| Oxides | Ce_{0.25} wt % | Ce_{0.5} wt % | Ce_{1.0} wt % |
| TiO₂ | 0.063 | 0.063 | 0.063 |
| ZnO | 0 | 0 | 0 |
| Fe₂O₃ | 0.047 | 0.047 | 0.047 |
| CeO₂ | 0.25 | 0.5 | 1 |

Properties

| | | | |
|---|---|---|---|
| T_{UV} % | 38.88 | 29.19 | 19.94 |
| T_{V} % | 91.784 | 90.32 | 89.138 |
| L* | 96.71 | 96.09 | 95.58 |
| a* | −0.33 | −0.63 | −1.05 |
| b* | 0.83 | 1.37 | 2.30 |
| / | 5.20 | 5.11 | 5.21 |
| FeO % (Spectral) | 28.22 | 30.04 | 30.50 |

TABLE 6

| Oxides | Ex. 6 Ce_{0.5}Fe_{0.125} wt % | Ex. 7 Ce_{1.0}Fe_{0.25} wt % |
|---|---|---|
| TiO₂ | 0.063 | 0.063 |
| ZnO | 0 | 0 |
| Fe₂O₃ | 0.125 | 0.25 |
| CeO₂ | 0.50 | 1.00 |

Properties

| | | |
|---|---|---|
| T_{UV} % | 25.89 | 15.94 |
| T_{V} % | 90.209 | 88.787 |
| L* | 96.02 | 95.38 |
| a* | −0.93 | −1.26 |
| b* | 2.57 | 4.65 |
| / | 5.18 | 5.19 |
| FeO % (Spectral) | 30.66 | 31.58 |

TABLE 7

| | Ex. 8 | Ex. 9 |
|---|---|---|
| Oxides | Ce_{0.5}Fe_{0.125}Zn_{0.125} wt % | Ce_{0.5}Zn_{0.5} wt % |
| TiO₂ | 0.063 | 0.063 |
| ZnO | 0.125 | 0.5 |
| Fe₂O₃ | 0.125 | 0 |
| CeO₂ | 0.5 | 0.5 |

Properties

| | | |
|---|---|---|
| T_{UV} % | 26.29 | 28.22 |
| T_{V} % | 89.50 | 90.87 |
| L* | 95.74 | 96.34 |
| a* | −0.54 | −0.26 |
| b* | 2.03 | 0.84 |
| / | 5.20 | 5.18 |
| FeO % (Spectral) | 32.02 | 29.54 |

### Aspects:

Example 1: A glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide, and wherein the glass is substantially free of erbium.

Example 2: The glass of any examples herein, particularly example 1, wherein the glass is a soda-lime composition further comprising: from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; and from 0 to about 1 wt % of Li₂O.

Example 3: The glass of any examples herein, particularly examples 1 or 2, wherein the glass further comprises from about 0 to about 0.5 wt % of SO₃.

Example 4: The glass of any examples herein, particularly examples 1-3, wherein the glass further comprises from 0 to about 0.02 wt % of cobalt oxide.

Example 5: The glass of any examples herein, particularly examples 1-4, wherein the glass further comprises from 0 to about 0.02 wt % of selenium

Example 6: The glass of any examples herein, particularly examples 1-5, wherein the glass further comprises from about 0.01 to about 1 wt % of manganese oxide.

Example 7: The glass of any examples herein, particularly examples 1-6, further comprising an amount of CuO, Cu₂O, NiO, Cr₂O₃, Sb₂O₃, P₂O₅, As₂O₃, or a combination thereof.

Example 8: The glass of any examples herein, particularly examples 1-7, wherein the glass exhibits transmission of less than about 45% in a wavelength range from about 300 to about 380 nm.

Example 9: The glass of any examples herein, particularly examples 1-8, wherein the glass exhibits transmission equal to or greater than about 80% in a wavelength range from greater than about 380 nm to about 780 nm.

Example 10: The glass of any examples herein, particularly examples 1-9, wherein the glass is substantially colorless.

Example 11: The glass of any examples herein, particularly examples 1-10, wherein the glass exhibits a* from about −3 to about +3.

Example 12: The glass of any examples herein, particularly examples 1-11, wherein the glass exhibits b* from about 0 to about +3.

Example 13: The glass of any examples herein, particularly examples 1-12, wherein the glass exhibits a redox value from 0% to about 50%.

Example 14: An article comprising the glass of any examples herein, particularly examples 1-13.

Example 15: The article of any examples herein, particularly example 14, wherein the article comprises foodware, tableware, hollowware, jars, optical fibers, hollow fibers, lab-usable containers, art and craft glass objects, or any combination thereof.

Example 16: The article of any examples herein, particularly example 15, wherein the article is formed by pressed and/or blown or blow-and-blow process.

Example 17: The article of any examples herein, particularly example 14, comprising flat glass, windows, windshields, solar cell parts, art and craft glass objects, laser host materials, or any combination thereof.

Example 18: The article of any examples herein, particularly example 17, wherein the article is formed by a flat/float process.

Example 19: A glass article comprising a glass comprising: from about 0.09 to about 1.00 wt % of cerium oxide; from about 0.01 to less than 0.25 wt % of iron oxide; from about 0.01 to about 2.0 wt % of zinc oxide; greater than 0 wt % to about 0.1 wt % of titanium oxide, and wherein the glass is substantially free of erbium.

Example 20: A glass article of any examples herein, particularly example 19, wherein the glass is a soda-lime composition, further comprising: from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; and from 0 to about 1 wt % of Li₂O.

Example 21: The glass article of any examples herein, particularly examples 19-20, wherein the glass further comprises from about 0 to about 0.5 wt % of SO₃.

Example 22: The glass article of any examples herein, particularly examples 19-21, wherein the glass further comprises from 0 to about 0.02 wt % of Co oxide.

Example 23: The glass article of any examples herein, particularly examples 19-22, wherein the glass further comprises from 0 to about 0.02 wt % of selenium.

Example 24: The glass article of any examples herein, particularly examples 19-23, wherein the glass further comprises from about 0.01 to about 1 wt % of manganese oxide.

Example 25: The glass article of any examples herein, particularly examples 19-24, further comprising an amount of CuO, Cu₂O, NiO, Cr₂O₃, Sb₂O₃, P₂O₅, As₂O₃, or a combination thereof.

Example 26: The glass article of any examples herein, particularly examples 19-25, wherein the glass exhibits transmission of less than about 45% in a wavelength range from about 300 to about 380 nm.

Example 27: The glass article of any examples herein, particularly examples 19-26, wherein the glass exhibits transmission equal to or greater than about 80% in a wavelength range from about 380 nm to about 780 nm.

Example 28: The glass article of any examples herein, particularly examples 19-27, wherein the glass is substantially colorless

Example 29: The glass article of any examples herein, particularly examples 19-28, wherein the glass exhibits a* from about −3 to about +3.

Example 30: The glass article of any examples herein, particularly examples 19-29, wherein the glass exhibits b* from about 0 to about +3.

Example 31: The glass article of any examples herein, particularly examples 19-30, wherein the glass exhibits a redox value from about 0% to about 50%.

Example 32: The glass article of any examples herein, particularly examples 19-31, wherein the article comprises foodware, tableware, cookware, hollowware, jars, optical fibers, hollow fibers, lab-usable containers, art and craft glass objects, or any combination thereof.

Example 33: The glass article of any examples herein, particularly example 32, wherein the glass article is formed by pressed and/or blown or blow-and-blow process.

Example 34: The glass article of any examples herein, particularly examples 19-31, comprising flat glass, windows, windshields, solar cell parts, art and craft glass objects, laser host materials, or any combination thereof.

Example 35: The glass article of any examples herein, particularly example 34, wherein the glass article is formed by a flat/float process.

Example 36: A method comprising: a) providing: from about 65 to about 75 wt % of SiO₂; from about 8 to about 20 wt % of Na₂O; from 0 to about 15 wt % of CaO; from 0 to about 10% of MgO; from 0 to about 5 wt % of Al₂O₃; from 0 to about 3 wt % of B₂O₃; from 0 to about 3 wt % of K₂O; from 0 to about 1 wt % of Li₂O; from about 0.09 to about 1.00 wt % of cerium oxide; from about 0.01 to about 0.25 wt % of iron oxide; from about 0.01 to about 2.0 wt % of zinc oxide; and great than 0 wt % to less than about 0.08 wt % of titanium oxide; b) forming a homogeneous mixture; c) melting the mixture at a temperature from about 1,400 °C to about 1,500 °C for a first time to form a melted mixture, and d) forming any of the disclosed herein glasses, wherein the glass is substantially free of erbium.

Example 37: The method of any examples herein, particularly example 36, wherein the forming of the glass comprises cooling the melted mixture to room temperature.

Example 38: The method of any examples herein, particularly example 36, wherein the melted mixture is annealed prior to the cooling at a temperature of about 520 to about 590 °C.

Example 39: The method of any examples herein, particularly examples 36-38, wherein the method further comprises forming an article comprising the glass.

Example 40: The method of any examples herein, particularly example 39, wherein a step of forming the article comprises a flat/float process.

Example 41: The method of any examples herein, particularly example 39, wherein forming the article comprises a pressed and/or blown or blow-and-blow process.

What is claimed is:

1. A glass comprising:
from about 0.09 to about 1.00 wt % of cerium oxide;
from about 0.01 to less than 0.25 wt % of iron oxide;
from about 0.01 to about 2.0 wt % of zinc oxide;
greater than 0 wt % to about 0.1 wt % of TiO₂, and wherein
the glass is substantially free of erbium.

2. The glass of claim 1, wherein the glass is a soda-lime composition, further comprising:
from about 65 to about 75 wt % of SiO₂;
from about 8 to about 20 wt % of Na₂O;
from 0 to about 15 wt % of CaO;
from 0 to about 10% of MgO;
from 0 to about 5 wt % of Al₂O₃;
from 0 to about 3 wt % of B₂O₃;
from 0 to about 3 wt % of K₂O; and
from 0 to about 1 wt % of Li₂O.

3. The glass of claim 1 or 2, wherein the glass further comprises from about 0 to about 0.5 wt % of SO₃.

4. The glass of any one of claims 1-3, wherein the glass further comprises from 0 to about 0.02 wt % of cobalt oxide.

5. The glass of any one of claims 1-4, wherein the glass further comprises from 0 to about 0.02 wt % of selenium.

6. The glass of any one of claims 1-5, wherein the glass further comprises from about 0.01 to about 1 wt % of manganese oxide.

7. The glass of any one of claims 1-6, further comprising an amount of CuO, Cu₂O, NiO, Cr₂O₃, Sb₂O₃, P₂O₅, As₂O₃, or a combination thereof.

8. The glass of any one of claims 1-7, wherein the glass exhibits transmission of less than about 45% in a wavelength range from about 300 to about 380 nm.

9. The glass of any one of claims 1-8, wherein the glass exhibits transmission equal to or greater than about 80% a wavelength range from greater than about 380 nm to about 780 nm.

10. The glass of any one of claims 1-9, wherein the glass is substantially colorless.

11. The glass of any one of claims 1-10, wherein the glass exhibits a* from about −3 to about +3.

12. The glass of any one of claims 1-11, wherein the glass exhibits b* from about 0 to about +3.

13. The glass of any one of claims 1-12, wherein the glass exhibits a redox value from 0% to about 50%.

14. An article comprising the glass of any one of claims 1-13.

15. The article of claim 14, wherein the article comprises foodware, tableware, hollowware, jars, optical fibers, hollow fibers, lab-usable containers, art and craft glass objects, or any combination thereof.

16. The article of claim 15, wherein the article is formed by pressed and/or blown or blow-and-blow process.

17. The article of claim 14, comprising flat glass, windows, windshields, solar cell parts, art and craft glass objects, laser host materials, or any combination thereof.

18. The article of claim 17, wherein the article is formed by a flat/float process.

19. A glass article comprising a glass comprising:
from about 0.09 to about 1.00 wt % of cerium oxide;
from about 0.01 to about 0.25 wt % of iron oxide;
from about 0.01 to about 2.0 wt % of zinc oxide;
great than 0 wt % to less than about 0.08 wt % of titanium oxide and wherein the glass is substantially free of erbium.

20. The glass article of claim 19, wherein the glass is a soda-lime composition, further comprising:
from about 65 to about 75 wt % of SiO₂;
from about 8 to about 20 wt % of Na₂O;
from 0 to about 15 wt % of CaO;
from 0 to about 10% of MgO;
from 0 to about 5 wt % of Al₂O₃;
from 0 to about 3 wt % of B₂O₃;
from 0 to about 3 wt % of K₂O; and
from 0 to about 1 wt % of Li₂O.

21. The glass article of claim 19 or 20, wherein the glass further comprises from about 0 to about 0.5 wt % of SO₃.

22. The glass article of any one of claims 19-21, wherein the glass further comprises from 0 to about 0.02 wt % of cobalt oxide.

23. The glass article of any one of claims 19-22, wherein the glass further comprises from 0 to about 0.02 wt % of selenium.

24. The glass article of any one of claims 19-23, wherein the glass further comprises from about 0.01 to about 1 wt % of manganese oxide.

25. The glass article of any one of claims 19-24, further comprising an amount of CuO, Cu₂O, NiO, Cr₂O₃, Sb₂O₃, P₂O₅, As₂O₃, or a combination thereof.

26. The glass article of any one of claims 19-25, wherein the glass exhibits transmission of less than about 45% in a wavelength range from about 300 to about 380 nm.

27. The glass article of any one of claims 19-26, wherein the glass exhibits transmission equal to or greater than about 80% in a wavelength range from greater than about 380 nm to about 780 nm.

28. The glass article of any one of claims 19-27, wherein the glass is substantially colorless.

29. The glass article of any one of claims 19-28, wherein the glass exhibits a* from about −3 to about +3.

30. The glass article of any one of claims 19-29, wherein the glass exhibits b* from about 0 to about +3.

31. The glass article of any one of claims 19-30, wherein the glass exhibits a redox value from about 0% to about 50%.

32. The glass article of any one of claims 19-31, wherein the article comprises foodware, tableware, cookware, hollowware, jars, optical fibers, hollow fibers, lab-usable containers, art and craft glass objects, or any combination thereof.

33. The glass article of claim 32, wherein the glass article is formed by pressed and/or blown or blow-and-blow process.

34. The glass article of any one of claims 19-31, comprising flat glass, windows, windshields, solar cell parts, art and craft glass objects, laser host materials, or any combination thereof.

35. The glass article of claim 34, wherein the glass article is formed by a flat/float process.

36. A method comprising:
a) providing:
from about 65 to about 75 wt % of SiO₂;
from about 8 to about 20 wt % of Na₂O;
from 0 to about 15 wt % of CaO;
from 0 to about 10% of MgO;
from 0 to about 5 wt % of Al₂O₃;
from 0 to about 3 wt % of B₂O₃;
from 0 to about 3 wt % of K₂O;
from 0 to about 1 wt % of Li₂O;
from about 0.09 to about 1.00 wt % of cerium oxide;
from about 0.01 to about 0.25 wt % of iron oxide;
from about 0.01 to about 2.0 wt % of zinc oxide; and
great than 0 wt % to less than about 0.08 wt % of titanium oxide;
b) forming a homogeneous mixture;
c) melting the mixture at a temperature from about 1,400 °C to about 1,500 °C for a first time to form a melted mixture, and
d) forming the glass of any one of claims 1-18, wherein the glass is substantially free of erbium.

37. The method of claim 36, wherein the forming of the glass comprises cooling the melted mixture to room temperature.

38. The method of claim 36, wherein the melted mixture is annealed prior to the cooling at a temperature of about 520 to about 590 °C.

39. The method of any one of claims 36-38, wherein the method further comprises forming an article comprising the glass.

40. The method of claim 39, wherein a step of forming the article comprises a flat/float process.

41. The method of claim 39, wherein a step of forming the article comprises a pressed and/or blown or blow-and-blow process.
